(19) United States
(12) Patent Application Publication
(10) Pub. No.: US 2010/0290831 A1
(43) Pub. Date: Nov. 18, 2010

(54) COUPLING ASSEMBLY FOR FURNITURE COMPONENTS

(75) Inventors: Marvin K. Burnett, Archbold, OH (US); Terry W. Armey, Napoleon, OH (US); John R. Autry, Wauseon, OH (US); Neal Flfer, Napoleon, OH (US); Richard A. Nelson, Napoleon, OH (US); Daniel J. Sauder, Wauseon, OH (US); Myrl D. Sauder, Archbold, OH (US); Troy E. Tedrow, Wauseon, OH (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(73) Assignee: Sauder Woodworking Company, Archbold, OH (US)

(21) Appl. No.: 12/632,378

(22) Filed: Dec. 7, 2009

Related U.S. Application Data
(63) Continuation of application No. 12/386,286, filed on Apr. 16, 2009, now abandoned.
(60) Provisional application No. 61/051,502, filed on May 8, 2008.

(51) Int. Cl. F16B 12/46; B23P 19/00

(52) U.S. Cl. 403/381; 29/462

(57) ABSTRACT

Coupling assemblies (2) are utilized to assemble a storage cube (1) having a top member (10), right member (12), bottom member (14) and left member (16). Adjacent members are coupled together through the use of T-tongues (20, 40, 44, 48) received within corresponding ones of T-slots (18, 38, 42, 46). The T-tongues and T-slots terminate certain distances (24, 36) from edges of the members (10, 12, 14, 16) thereby providing for blind configurations allowing for edges of members (10, 12, 14, 16) to be profiled, finished or otherwise decorated.

### CROSS-REFERENCE TO RELATED APPLICATIONS

This application is a continuation of U.S. patent application Ser. No. 12/386,286 filed on Apr. 16, 2009, which claims priority of U.S. Provisional Patent Application Ser. No. 61/051,502 filed on May 8, 2008.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention is directed to a coupling assembly for joining together two or more furniture members and, more particularly, to a coupling assembly utilizing a tongue and groove configuration.

2. Background Art

A number of different types of commercial products available to consumers utilize multiple structural members, and means for securing together such structural members. Such consumer products may include structures sold to consumers in what could be characterized as an “unassembled” state. Where consumers are expected to assemble structures from component pieces, it is particularly advantageous to provide the consumers with connecting means which facilitate the ease of connecting together those component pieces requiring relatively secure connections.

A need for providing structures which facilitate assembly of products by consumers (which are purchased in an unassembled condition) has particular application in “ready-to-assemble” furniture. Ready-to-assemble or “RTA” furniture typically consists of manufactured furniture components that are sold to consumers in an unassembled condition. The consumer assembles the components to construct a particular furniture item, which can include such things as bookcases, storage cubes, desks, tables, stands and the like. There is a need for quick, easy assembly, without a requirement for tools or hardware. In particular, the aesthetic design elements of the components or members of a furniture item are essential to the appeal of the furniture item.

An advance in the technical field of coupling assemblies for furniture components was achieved and is disclosed in Short, et. al., U.S. Pat. No. 5,499,886, issued Mar. 19, 1996. The Short, et. al. patent discloses a coupling assembly for joining together two furniture members, with a first member having an outwardly projecting tongue. The tongue includes a central portion adjacent to the first member, and an enlarged terminal portion spaced from the first member. The terminal portion consists of a series of walls forming a geometric configuration. The two furniture members also include a second member which, in part, defines a groove. The groove has a configuration corresponding to the central portion and the terminal portion of the tongue. The groove receives the tongue portions so as to join together the first member and the second member.

To date, coupling assemblies employing a tongue and groove configuration with an enlarged terminal portion have been limited to assemblies where it would be acceptable for the tongue and groove to show on both ends of the assembly.

### SUMMARY OF THE INVENTION

In accordance with the invention, a tongue and groove assembly can be provided in which the tongue and groove are terminated at a point such that neither exits the end of the respective furniture component member to which the tongue or groove is associated. Accordingly, the edges of the furniture members may be profiled, with the tongue and groove assembly essentially “hidden” from view. Proper member alignment may also be achieved. In this regard, and in accordance with certain aspects of the invention, proper registration of the furniture members is provided by limiting the travel of the tongue within the groove slot. The terminal point of the tongue may engage the terminal point of the groove, with such registration aiding in the proper assembly by consumer, and so as to ensure an aesthetically pleasing appearance for the overall furniture item.

Still further, coupling assemblies in accordance with the invention provide for the use of tongue and groove coupling configurations to be utilized in a myriad of joining applications, since the joint termination is not visible. In accordance with further aspects of the invention, the member edges may be profiled using methods such as soft-forming, foiling or other decorative embodiments.

In accordance with one embodiment of a coupling assembly in accordance with the invention, the assembly is utilized for purposes of joining furniture members, with a first member having an outwardly projecting T-shaped tongue along an edge of the first member. The subject tongue terminates at a point a measured distance from one edge of the member. A second one of the furniture members includes a corresponding inward projecting T-shaped slot in the face of the second member. The subject slot begins on one edge of the member, and terminates at a point a measured distance from a second edge. The first member slides into the second member to a point up to where either the edges of the members align, or the terminal points of the T-shaped slot and the T-shaped tongue coincide.

Further in accordance with the invention, it is an object of the invention to hide the coupling assembly. In view of the T-shaped slot and T-shaped tongue terminating at a measured distance from the front edge of the members, the coupling assembly is not seen from the front of the assembly. Accordingly, the coupling assembly can be characterized as being “blind.”

In addition, a further object of the present invention is to allow the front edges of the members to be profiled, finished, or otherwise decorated. Another object of the invention is to provide a coupling method which maintains proper alignment between the members of a furniture assembly.

Other objects and advantages of the present invention will become apparent upon review of the drawings and the following detailed description of an illustrative embodiment of the invention.

### BRIEF DESCRIPTION OF THE DRAWINGS

FIG. 1 is a perspective view of a storage cube showing four furniture members joined together by coupling assemblies in accordance with the present invention;

FIG. 2 is a perspective and exploded view of the storage cube illustrated in FIG. 1 and showing various views of the four furniture members which utilize the present invention to assemble the storage cube;

FIG. 3 is a perspective view of the storage cube of FIG. 1, shown in a partially assembled state and further showing various views of the four furniture members utilizing the present invention;

FIG. 4 is a further perspective view, rotated relative to the perspective view of FIG. 3 of the storage cube of FIG. 1 in a partially assembled state and showing various views of the four furniture members utilizing the present invention;

FIG. 5 is a perspective and partial view illustrating a portion of two of the furniture members of the storage cube to be interlocked, and further showing a T-tongue and a T-slot utilized by the present invention to interlock the two furniture members;

FIG. 6 is a perspective and partial view of one corner of one of the furniture members utilized as part of the storage cube, and illustrating the relative positioning of the blind T-tongue on the furniture member; and

FIG. 7 is a perspective and partial view of one of the furniture members utilized in the storage cube, and illustrating the relative positioning of the blind T-slot groove of the present invention.

### DETAILED DESCRIPTION OF THE INVENTION

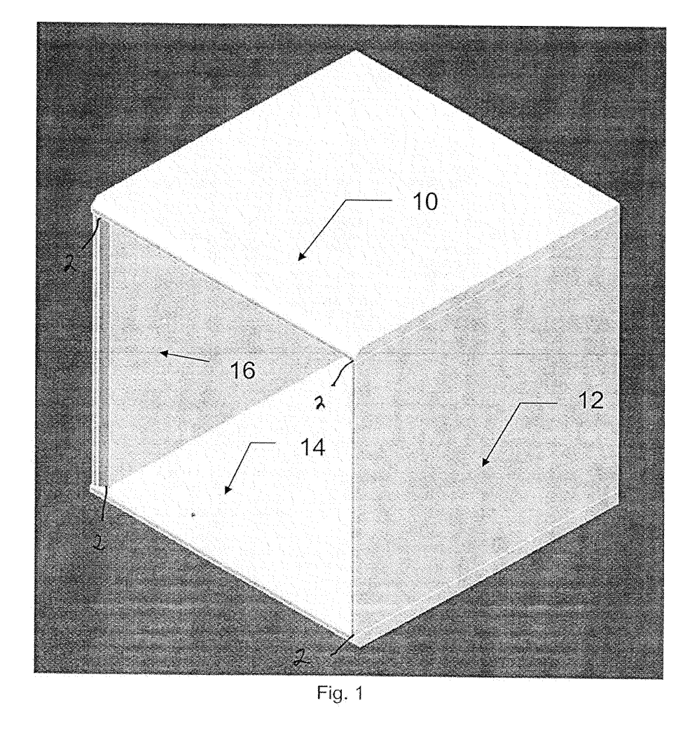

The principles of the present invention will now be described with respect to a storage cube assembly 1, utilizing coupling assemblies in accordance with the invention and illustrated in FIGS. 1-7. As will be apparent from the subsequent disclosure, the storage cube assembly 1 utilizes coupling assemblies having tongue and groove configurations which terminate at points such that neither the tongue nor the groove exit an end of the respective furniture component members to which the tongue or groove is associated. Advantageously, this feature permits profiling of the edges of the furniture members, in that the tongue and groove configurations are essentially “hidden” from view. Further, the coupling assembly configurations in accordance with the invention still permit proper member alignment.

Turning to the drawings, and first with respect to FIG. 1, coupling assemblies in accordance with the invention will be illustrated and described with respect to the illustrative embodiment comprising the storage cube assembly 1, shown in an assembled state. The storage cube 1 is a furniture assembly consisting of four separate components. These components include what are characterized herein as a top member 10, right member 12, bottom member 14 and left member 16. The directional references to these members (top, right, and the like) are for purposes of description and do not represent any particular configuration or directional environment in which the storage cube assembly 1 must be utilized. Instead, the directional references represent conventional references if the storage cube assembly 1 is viewed inwardly from outside of the opening shown in FIG. 1. The four members 10, 12, 14 and 16 can be constructed of various types of materials. As an example, these four members can be made of natural or synthetic particles or fibers that have been pressed or otherwise formed into composite furniture components. Examples of natural particles can include wood and various grasses such as straw. Examples of synthetic particles and/or fibers can include plastic and fiberglass. A thin laminate, paint, stain, varnish or other surface coating can be applied to the surfaces of the furniture members. It should be understood that the present invention is applicable to furniture components that can be comprised of a wide variety of shapes and purposes. The storage cube assembly 1 described and illustrated herein is only one exemplary embodiment of a furniture component utilizing the present invention. That is, the principal novel concepts of the invention are not limited to the embodiment described herein.

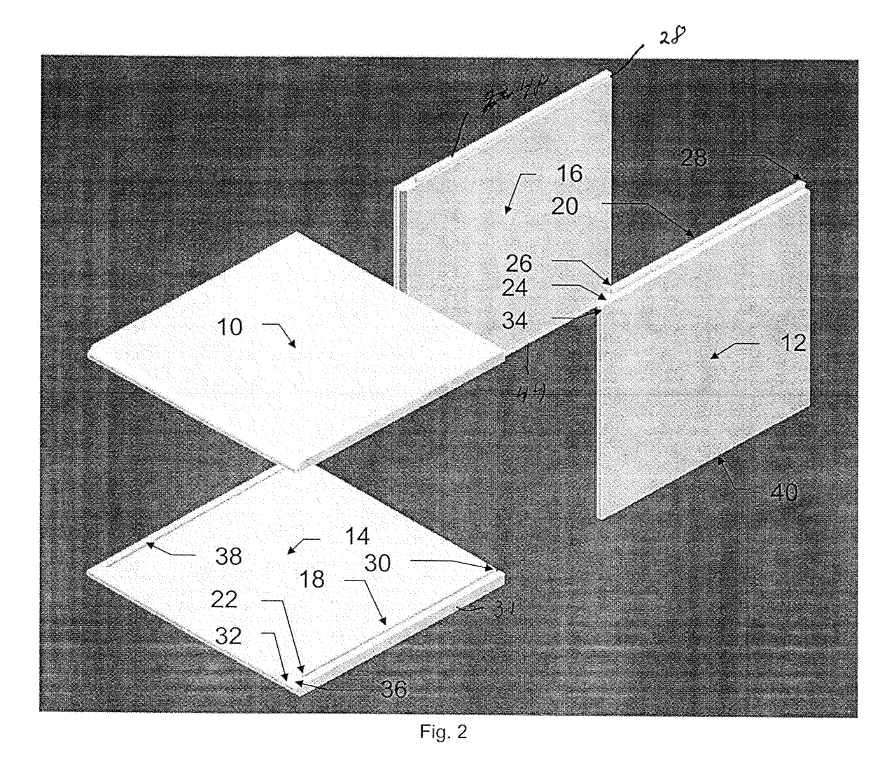

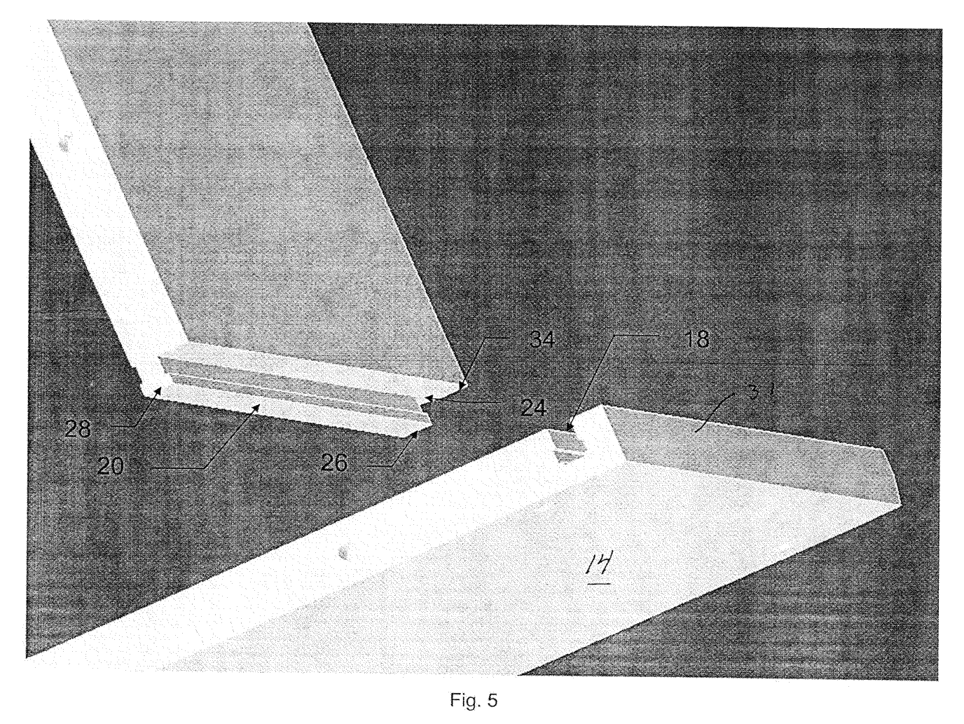

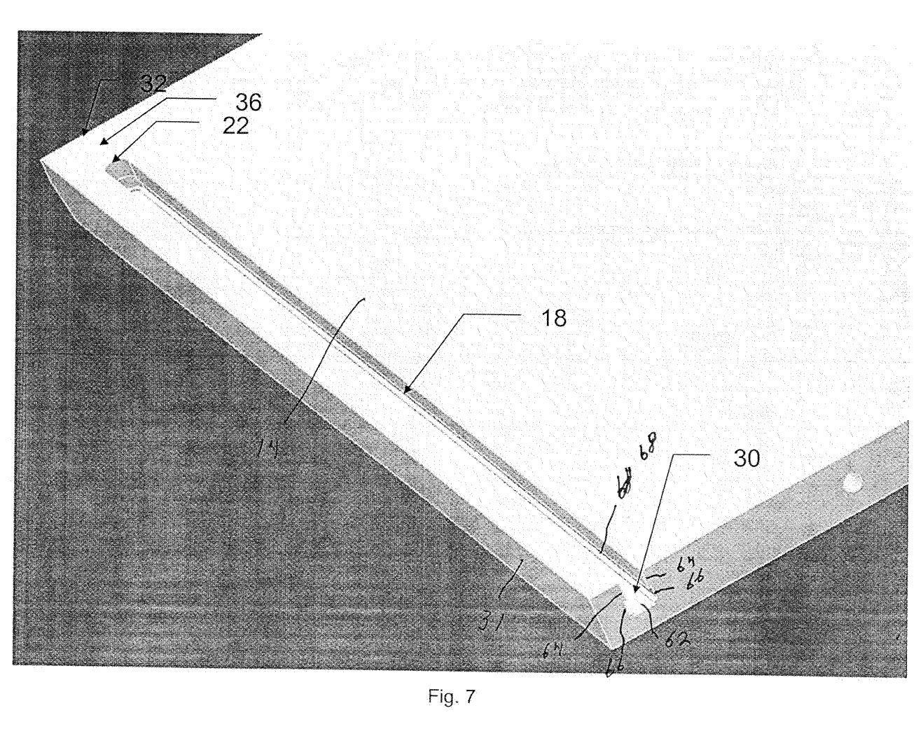

With reference to FIGS. 2, 5 and 7, the top member 10 and bottom member 14 will now be described, along with the portions of the coupling assemblies in accordance with the invention which are associated therewith. The top member 10 and bottom member 14 can each have a square or rectangular configuration, and are preferably identical. The bottom member 14 includes what is characterized as a left T-slot 38 and a right T-slot 18. It should be noted that FIG. 2 illustrates both of the T-slots 18, 38 while FIGS. 5 and 7 illustrate only the T-slot 18. The left T-slot 38 and the right T-slot 18 are substantially identical. With reference to each of the drawing FIGS. 2, 5 and 7, the right T-slot 18 commences at a rear edge 30 of the member 14. The right T-slot 18 continues in a configuration which is maintained substantially parallel to a side 31 toward the front of the member 14. The right T-slot 18 terminates within the member 14 at a location which is illustrated as terminal point 22 in FIGS. 2 and 7.

As particularly illustrated in FIGS. 2 and 7, the terminal point 22 of the right T-slot 18 can be characterized as being a measured distance 36 from a front edge 32 of the bottom member 14. In view of the right T-slot 18 terminating at the terminal point 22, and not continuing through to the front edge 32, the right T-slot 18 can be characterized as being “blind” to the front edge 32 of the member 14. This blind configuration allows for the front edge 32 of the member 14 to be profiled, finished or otherwise decorated. In this regard, the measured distance 36 can be any value which may be considered suitable to the design of the particular embodiment within which coupling assemblies in accordance with the invention are being utilized.

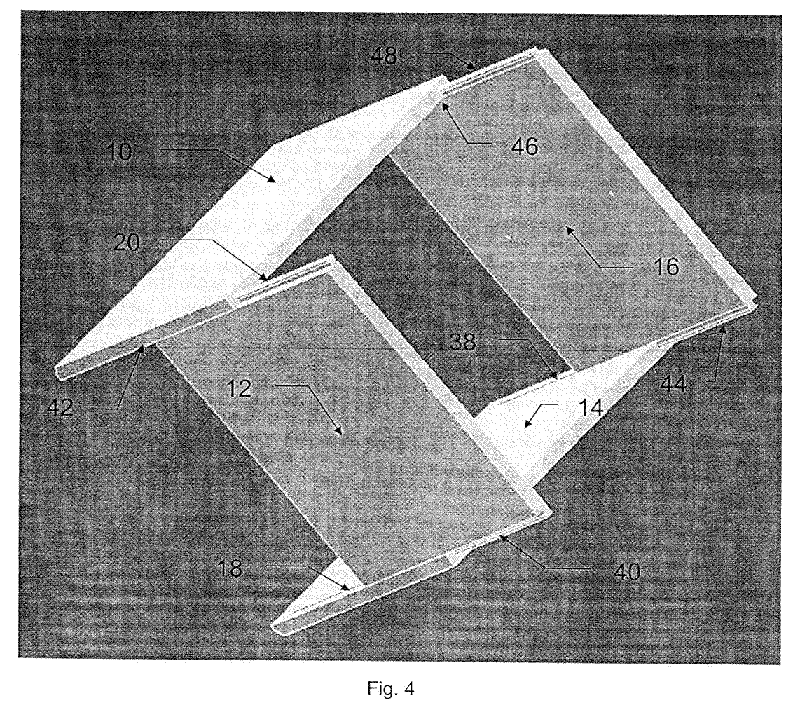

With reference primarily to FIGS. 2, 5 and 6, the right member 12 and the left member 16 will now be described, along with the portions of the coupling assemblies in accordance with the invention which are associated therewith. The right member 12 and the left member 16 can each have a square or rectangular configuration (or other configuration, if desired), and are preferably identical. The right member 12 includes what is characterized as a top T-tongue 20 (FIGS. 2, 5 and 6) and a bottom T-tongue 40 (primarily shown in FIGS. 2, 3 and 4). The top T-tongue 20 and bottom T-tongue 40 are preferably identical. Correspondingly, the left member 16 includes what is characterized as a top T-tongue 48 (FIGS. 2, 3 and 4) and a bottom T-tongue 44 (primarily shown in FIG. 4). The top T-tongue 48 is preferably identical to the bottom T-tongue 44. Further, the top T-tongue 48 and top T-tongue 20 are also preferably identical. In addition, bottom T-tongue 44 is substantially identical to bottom T-tongue 40. In view of all the foregoing, the T-tongues associated with the right member 12 and left member 16 will now be described primarily with respect to the top T-tongue 20 of right member 12, keeping in mind that the left member 16 and the other T-tongues have substantially identical configurations. With reference again to each of the drawing FIGS. 2, 5 and 6, the top T-tongue 20 commences at a rear edge 28 of the member 12. The top T-tongue 20 continues in a configuration substantially parallel to a side 29, toward the front of the member 12. The top T-tongue 20 terminates on the member 12 at a location which is illustrated as terminal point 26 in FIGS. 2, 5 and 6.

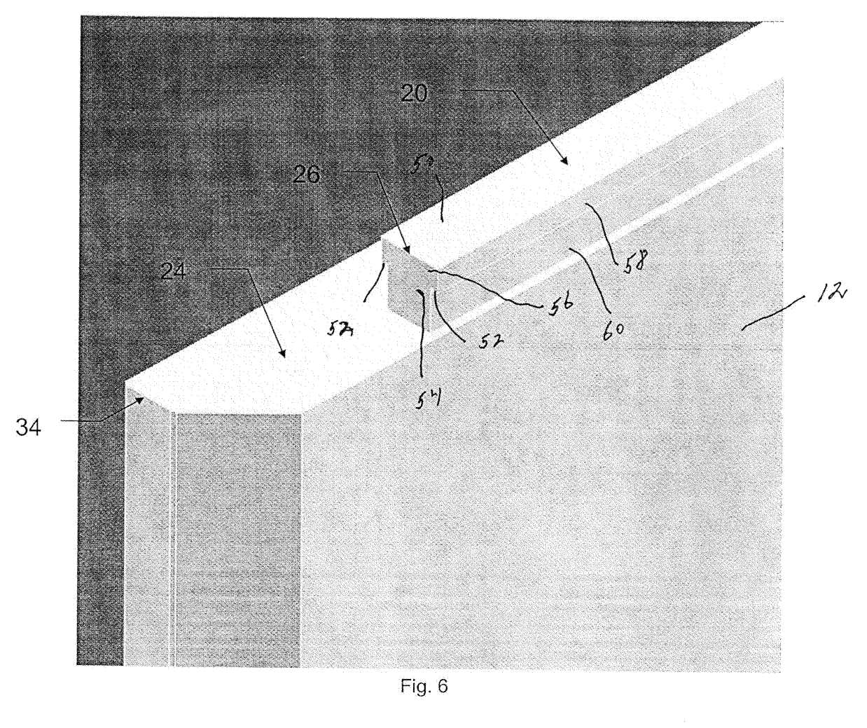

As particularly illustrated in FIGS. 2 and 6, the terminal point 26 of the top T-tongue 20 can be characterized as being a measured distance 24 from a front edge 34 of the member 12. In view of the top T-tongue 20 terminating at the terminal point 26, and not continuing to the front edge 34, the top T-tongue 20 can be characterized as being “blind” to the front edge 34 of the member 12. This blind configuration allows for the front edge 34 of the member 12 to be profiled, finished or otherwise decorated. In this regard, the measured distance 24 can be any value which may be considered suitable to the design of the particular embodiment within which coupling assemblies in accordance with the invention are being utilized. It should be noted that the measured distance 24 and the previously described measured distance 36 can be equal, so as to align the front edge 32 of top member 10 or bottom member 14 with the front edge 34 of right member 12 or left member 14, as the case may be. Alternatively, the measured distances 24 and 36 can be unequal, dependent upon the particular design characteristics desired by the designer.

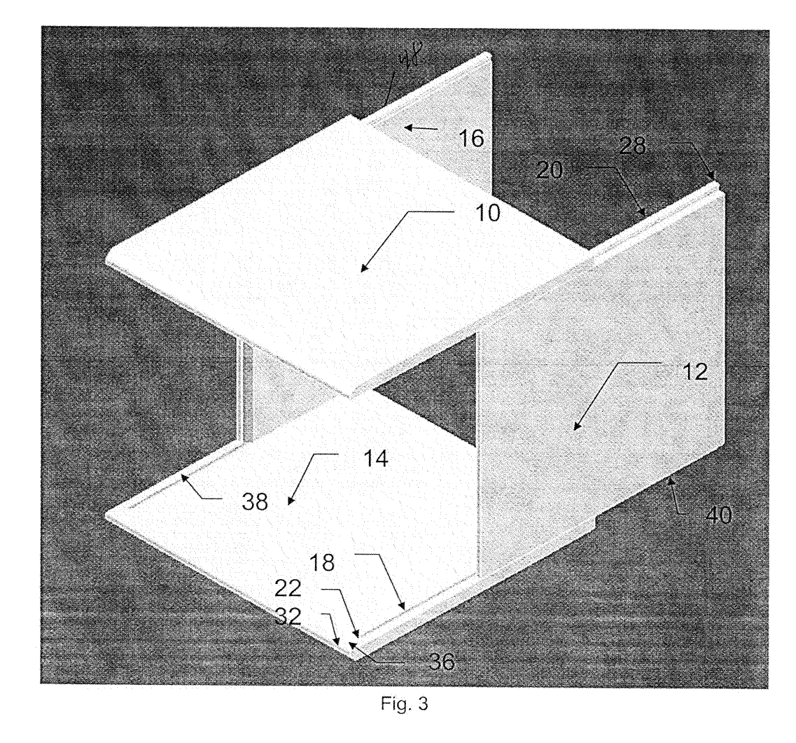

The assembly of the storage cube 1 in accordance with the invention will now be described, particularly with respect to FIGS. 3 and 4. With reference thereto, the illustrative embodiment of the invention comprising the storage cube 1 can be assembled in two steps. The first step can be accomplished by first engaging the top T-tongue 20 of the right member 12 with the right T-slot 42 of the top member 10. Correspondingly, the bottom T-tongue 40 of the right member 12 can be positioned so as to engage the right T-slot 18 of the bottom member 14. The right member 12 can then be slid along the T-slot 42 and the T-slot 18, until there is a full engagement of the tongues and slots, or the front edge surfaces are otherwise aligned.

Following this first step, a second step is initiated by engaging the top T-tongue 48 of the left member 16 with the left T-slot 46 of the top member 10. Correspondingly, the left T-slot 38 of the bottom member 14 can be received and engage the bottom T-tongue 44 of the left member 16. The left member 16 can then be slid along the T-slot 46 and the T-slot 38, until full engagement of the tongues and slots is accomplished, or the front edge surfaces are otherwise aligned. In the particular embodiment of the storage cube assembly 1 described and illustrated herein, the measured distance 24 and the measured distance 36 are shown as being equal, and provide for the alignment of the front edge surfaces and the full engagement of the T-tongues and T-slots to occur simultaneously. However, as previously mentioned, this concept of the measured distances being equal is not a requirement for other embodiments utilizing coupling assemblies in accordance with the invention.

For purposes of description, reference has been made throughout the prior description to “coupling assemblies.” For purposes of reference in the claims and the abstract, these coupling assemblies are identified as coupling assemblies 2 in FIG. 1. The reference number 2 essentially identifies the positions of the components which are being characterized as coupling assemblies 2. Specifically, each of the coupling assemblies 2 can be characterized as comprising one of the T-slots on one of the members of the storage cube 1, in combination with one of the T-tongues associated with an adjacent member of the storage cube 1.

It should be noted that various types of coupling assemblies may be utilized in accordance with the invention, which may be somewhat independent of the specific type of tongue and groove configuration utilized with the example embodiment of the storage cube 1. That is, configurations other than the specific T-slots and T-tongues described herein may be utilized, without departing from some of the principal concepts of the invention.

For purposes of a full disclosure, it is believed that the concept of tongue and groove configurations utilizing T-slots and T-tongues is known to those of ordinary skill in the relevant arts. An example embodiment of the use of tongue and groove configurations employing T-shaped configurations is disclosed in the previously identified Short, et. al., U.S. Pat. No. 5,499,886 issued Mar. 19, 1996. To more fully describe the particular embodiment of the tongue and groove configuration utilized herein, reference is first made to FIG. 6 and the top T-tongue 20 partially shown therein. The top T-tongue 20 includes a top wall 50 extending longitudinally along the entire length of the T-tongue 20. A T-portion 56 of the T-tongue 20 is formed with the top wall 50, side walls 58 and underside walls 52. Integral with the T-portion 56 is a central portion 54. The central portion 54 is formed on the member with side walls 60. A corresponding T-slot, such as the right T-slot 18, has a configuration illustrated, for example, in FIG. 7. With reference thereto, the T-slot 18 includes a bottom wall 62 longitudinally extending along the length of the slot 18. The slot 18 is further formed through side walls 64 which form an opening 68 outwardly from the slot 18. Positioned a predetermined distance from the opening 68 along the side wall 64 are a pair of lateral T-slot walls 66 extending laterally outwardly from each of the side walls 64. Each of the T-tongues and T-slots should be sized and configured so that the T-tongues may be snugly but releasably received within corresponding T-slots. The foregoing disclosure and description of the invention is illustrative and explanatory thereof, and various changes can be made to the invention within the scope of the appended claims.

It will be apparent to those skilled in the pertinent arts that other embodiments of coupling assemblies in accordance with the invention can be designed. That is, the principles of coupling assemblies in accordance with the invention are not limited to the specific embodiments described herein. Accordingly, it will be apparent to those skilled in the art that modifications and other variations of the above-described illustrative embodiment of the invention may be effected without departing from the spirit and scope of the novel concepts of the invention.

1. A furniture component comprising a plurality of furniture members adapted to be assembled together through coupling assemblies, for interconnecting adjacent ones of said furniture members, at least one of said coupling assemblies comprising:
a tongue mounted to a first surface of a first member of said plurality of furniture members, extending along said first surface and terminating a first predetermined distance from a first edge of said first member;
a slot formed within a first surface of a second member of said plurality of furniture members, commencing at an initial edge of said first surface of said second furniture member, and terminating a second predetermined distance from a first edge of said second member;
when said furniture component is assembled, said tongue is received within said slot so as to interlock together said first furniture member and said second furniture member; and
said first predetermined distance and said second predetermined distance are sufficient so that said coupling assembly is hidden from view from a front of said furniture component.

2. A furniture component in accordance with claim 1, characterized in that said tongue comprises a T-shaped configuration.

3. A furniture component in accordance with claim 2, characterized in that said slot formed within said first surface of said second member of said plurality of furniture members comprises a T-shaped configuration.

4. A furniture component in accordance with claim 1, characterized in that said tongue is mounted to said first surface of said first member of said plurality of furniture members commencing at an initial edge of said first surface of said first member of said plurality of furniture members.

5. A furniture component in accordance with claim 1, characterized in that said tongue mounted to said first surface of said first member of said plurality of furniture members commences a third predetermined distance away from an initial edge of said first surface of said first member of said plurality of furniture members.

6. A furniture component in accordance with claim 1, characterized in that said first predetermined distance is equal to said second predetermined distance.

7. A furniture component in accordance with claim 1, characterized in that said first predetermined distance differs from said second predetermined distance.

8. A furniture component in accordance with claim 1, characterized in that said tongue comprises:
a T-shaped portion formed with a top wall, first side walls and first underside walls;
a central portion integral with said T-shaped portion and formed on said first member of said plurality of furniture members with second side walls; and
said top wall extends longitudinally along the entire length of said tongue.

9. A furniture component in accordance with claim 1, characterized in that said slot comprises:
a bottom wall longitudinally extending along the length of said slot;
side walls forming an opening extending outwardly from said slot;
a pair of lateral T-slot walls positioned at a predetermined distance from said opening and extending laterally outwardly from each of said side walls; and
said slot is sized and configured, and said tongue is sized and configured, so that said tongue is snuggly but releasably received within said slot.

10. A furniture component in accordance with claim 1, characterized in that with said coupling assembly hidden from view from a front of said furniture component, said front of said furniture component can be profiled, finished or otherwise decorated.

11. A furniture component in accordance with claim 1, characterized in that said first member and said second member of said plurality of furniture members are manufactured at least in part from compressed wood particles.

12. A furniture component in accordance with claim 1, characterized in that the relative positioning of said first member and said second member of said plurality of said furniture members is determined in part by the quantitative relationship between said first predetermined distance and said second predetermined distance.

13. A coupling assembly for joining together at least two ready-to-assemble furniture members comprising a first furniture member and a second furniture member, said coupling assembly comprising:
a tongue mounted to a first surface of said first furniture member, extending along said first surface and terminating a first predetermined distance from a first edge of said first furniture member;
a slot formed within a first surface of said second member, extending along said second surface and terminating a second predetermined distance from a first edge of said second furniture member;
said tongue is received within said slot so as to interlock together said first furniture member and said second furniture member;
said first predetermined distance and said second predetermined distance are sufficient so that said coupling assembly is hidden from view from a front of a furniture component formed, at least in part, by said first furniture member and said second furniture member;
said tongue comprises a T-shaped portion formed with a top wall, first side walls and underside walls;
said tongue further comprises a central portion integral with said T-shaped portion, and formed on said first furniture member with second side walls; and
said slot comprises a bottom wall longitudinally extending along the lengths of said slot, with said slot further formed through third side walls forming an opening extending laterally outwardly from said slot, with a pair of lateral slot walls extending laterally outwardly from each of said third side walls, and positioned a predetermined distance from said opening.

14. A method for manufacture of a coupling assembly for interconnecting adjacent ones of furniture members of a furniture component, said method comprising:
mounting a tongue to a first surface of a first member of said furniture members, and extending said tongue along said first surface so as to terminate a first predetermined distance from a first edge of said first member;
forming a slot within a first surface of a second member of said furniture members, extending said slot along said first surface of said second furniture member, and terminating said slot at a second predetermined distance from a first edge of said second furniture member;
sizing and configuring said tongue and said slot so that said tongue is receivable within said slot; and
sizing and configuring said furniture components so that said first predetermined distance and said second predetermined distance are sufficient so that said coupling assembly will be hidden from view from a front of said furniture component when said coupling assembly is utilized for interconnecting said first furniture member and said second furniture member.
